(19) United States
(12) Patent Application Publication
(10) Pub. No.: US 2007/0011358 A1
(43) Pub. Date: Jan. 11, 2007

(54) Mechanisms to implement memory management to enable protocol-aware asynchronous, zero-copy transmits

(76) Inventors: John Wiegert, Aloha, OR (US); Annie Foong, Aloha, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,018

(22) Filed: Jun. 30, 2005

(51) Int. Cl. G06F 15/16

(52) U.S. Cl. 709/250

(57) ABSTRACT

Mechanisms to implement memory management to enable protocol-aware asynchronous, zero-copy transmits. A transport protocol engine exposes interfaces via which memory buffers from a memory pool in operating system (OS) kernel space may be allocated to applications running in an OS user layer. The memory buffers may be used to store data that is to be transferred to a network destination using a zero-copy transmit mechanism, wherein the data is directly transmitted from the memory buffers to the network via a network interface controller. The transport protocol engine also exposes a buffer reuse API to the user layer to enable applications to obtain buffer availability information maintained by the protocol engine. In view of the buffer availability information, the application may adjust its data transfer rate.

### FIELD OF THE INVENTION

The field of invention relates generally to computer systems and, more specifically but not exclusively relates to mechanisms to implement memory management to enable protocol-aware asynchronous, zero-copy transmits.

### BACKGROUND INFORMATION

The most common way to send data over a network, including the Internet, is to use the TCP/IP (Transmission Control Protocol/Internet Protocol) protocol. The primary reasons for this is that 1) TCP/IP provides a mechanism for guaranteed delivery by using a packet acknowledgement feedback method; and 2) most traffic sent over a network relates to documents or the like, thus requiring guaranteed delivery.

When data, such as a document, is transferred over a network, the data is formed into a bitstream that is divided and packaged into a number of “packets,” which are then sent over the network using the underlying network infrastructure and associated transport protocol. During this process, individual packets may be routed along different paths to reach the endpoint destination identified by the destination address in the packet headers, potentially causing the packets to arrive out-of-order. In addition, one or more packets may be dropped by the various network elements due to traffic congestion and the like.

TCP/IP addressed the foregoing problems by using sequence numbers and a packet delivery feedback mechanism. Typically, a respective TCP/IP software stack is maintained by the computers at the source and destination endpoints. The TCP/IP stack at the source is used to divide input data (e.g., a document in binary form) into sequentially-numbered packets, and to transmit the packets to a first hop along the transmit path. The TCP/IP stack at the destination endpoint is used to re-assemble the received packets based on the packet sequence numbers and to provide acknowledgement (ACK) message feedback for each packet that is received. Meanwhile the TCP/IP stack at the source monitors for the ACK messages. If a given packet does not receive an ACK message within a predetermined timeframe (e.g., sending of two packets), a duplicate copy of the packet is re-transmitted, with this process being repeated until all packets have been received at the destination, providing a guaranteed delivery function.

A majority of TCP processing overhead is incurred during cycles used for copying data between buffers. For example, a typical TCP/IP transfer of a document 100 from a source computer 102 to a destination computer 104 using a conventional technique is shown in FIG. 1. Initially, document 100 is stored in memory blocks 106 on multiple memory pages 107 in a user portion of system memory (a.k.a., user space) allocated to an application 108 running in an application layer of an operating system (OS) running on source computer 102. To transfer document 100, a TCP service 110 running in the OS kernel opens up one or more socket buffers 112 in a kernel portion of system memory (a.k.a., kernel space), and copies document data from memory blocks 106 in memory pages 107 into the socket buffer(s).

Once copied into a socket buffer, the data is divided into sequentially-numbered packets 114 that are generated by a TCP/IP software stack 116 under control of TCP service 110 and transmitted via a network interface controller (NIC) 118 over a network 120 to destination computer 104. Meanwhile, the TCP/IP stack maintains indicia that maps the data used to generate each packet, as well as its corresponding socket buffer 112. In response to receiving a packet, destination computer 104 returns an ACK packet 122 to source computer 102. Upon receipt of an ACK packet for a given transmitted packet, the corresponding indicia is marked as clear. A socket buffer may not receive any additional data from the application until all of its packets been successfully transferred. This conventional scheme requires copying one instance of document 100 into the socket buffers.

One approach to address this problem is to employ a zero-copy transmit, wherein data is transmitted directly from source buffers (e.g., memory pages) used by an application or OS. For example, Linux provides a zero-copy transmit using the sendpage( ) call, which enables data to be transferred directly from user-layer memory. Without kernel buffers to act as the intermediary, the application is now exposed to all the nuances of (i) underlying protocol; (ii) the delays of routers and intermediate proxies in the network; and (iii) clients at the other end of the network.

One of these nuances lies with the fact that the application cannot reuse its application buffers until it is fully acknowledged by the client. The application has two choices:
i) After returning asynchronously from a call, the application has to wait until the acknowledgements arrive before proceeding. The application cannot reuse a buffer until a call back reports that the ACK arrived. This nuance is especially prominent in protocols with complex congestion control mechanisms (e.g., TCP). The benefits gained from asynchronously returning immediately from a function call, is offset by the need to synchronize memory reuse notification.
ii) Under an implementation such as Linux sendpage( ), the application is oblivious to the underlying congestion control, and it is the responsibility of the operating system to take care of buffer reuse through its main memory management system. Linux sendpage( ) marks pages as reusable as acknowledgements arrive. Previously, in the conventional copy case, the socket buffer serves as the “throttling” mechanism. When it fills up, it applies back-pressure to the application, allowing the application to have some sense that it is sending data too fast. In the zero-copy case, the application has no control of how and when these buffers are reused. More succinctly, it has no knowledge of how fast the ACKs are coming back, and may proceed at a rate that overruns the network.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram of a computer/software architecture used to perform network transfer of data using a conventional copy scheme;

FIG. 2 is a schematic diagram of a computer/software architecture illustrating various components employed by one embodiment of the invention to effect a zero-copy transmit mechanism;

FIG. 3 is a schematic diagram illustrating further details of one embodiment of the zero-copy transmit mechanism, including details of a state of memory scheme used to provide feedback information to applications using the zero-copy transmit mechanism;

FIG. 4 is a schematic flow diagram illustrating operations performed during one implementation of the zero-copy transmit mechanism; and

FIG. 5 is a schematic diagram of a exemplary computer server via which various aspects of the embodiments described herein may be practiced.

### DETAILED DESCRIPTION

Embodiments of methods and apparatus for implementing memory management to enable protocol-aware asynchronous, zero-copy transmits are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments of the present invention described below address the shortcomings of existing techniques by providing a mechanism that enables an application and a transmit protocol engine to share access to common memory buffers, while at the same time providing a flow control mechanism that provides information indicative of network congestion. Under one aspect, the application and the protocol engine have shared responsibility of buffer reuse and acknowledgement notification. The application is able to control its own behavior (with respect to data transmission) based on its own requirements. The mechanism enables the application to decide whether to throttle back, or when appropriate, ignore the back-pressure and keep sending data until it is out of memory resources for a given pool. Thus, the application can be exposed to information about congestion control and throttling, but still retain its choice to act on that information.

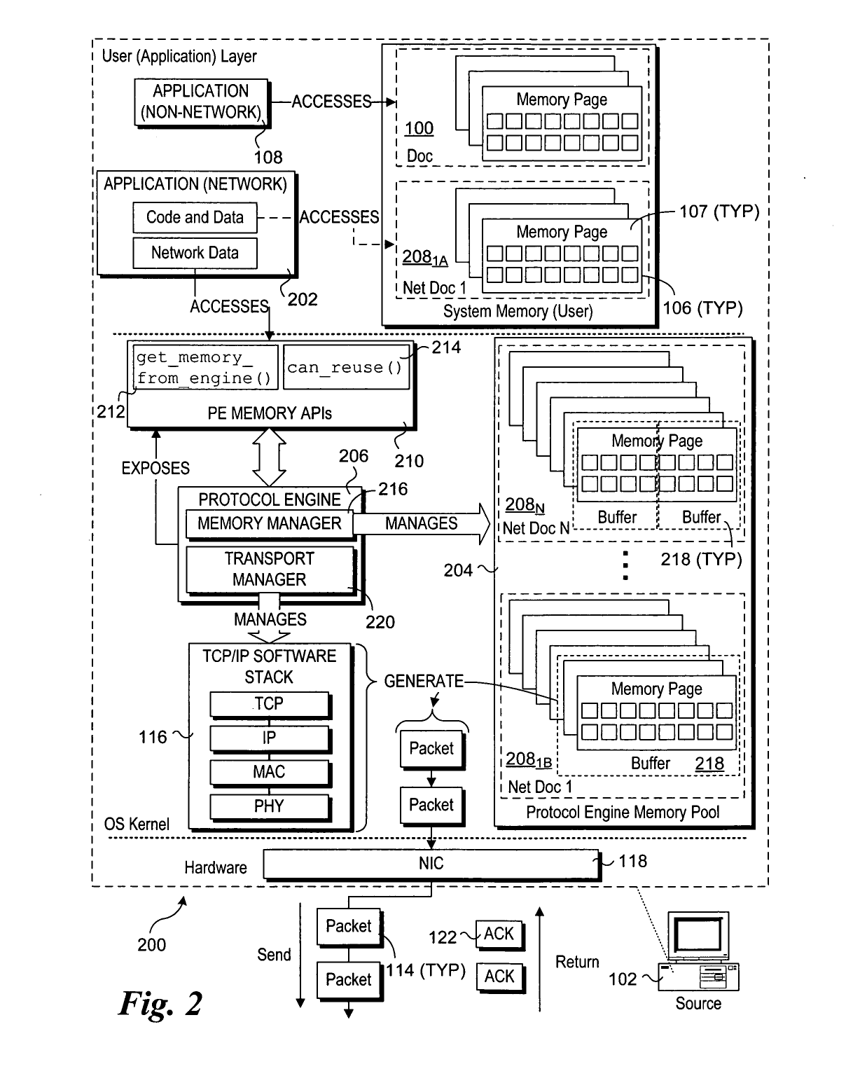

An exemplary implementation architecture 200 in accordance with one embodiment of the invention is shown in FIG. 2. As before, the architecture includes a user layer in which user applications are run, an OS kernel, and a hardware layer including a NIC 118. (It is noted that the architecture will also typically include a firmware layer used for run-time I/O services and the like, which is not shown for simplicity.) As illustrated, a non-network application 108 and a network application 202 are run in the user layer. The terms “non-network” and “network” in this context refer to whether the application is used to send data over a network as part of its normal operations. For example, applications such as word processors, spreadsheets, multi-media applications (e.g., DVD player), and single-user games are typically not used to send data over a network. In some instances, data can be sent from these types of applications; however, this is usually accomplished by employing another application or OS kernel service for this purpose. In contrast, applications such as web servers, e-mail applications, browsers, etc., perform numerous data transmissions over networks. These applications fall into the network application category.

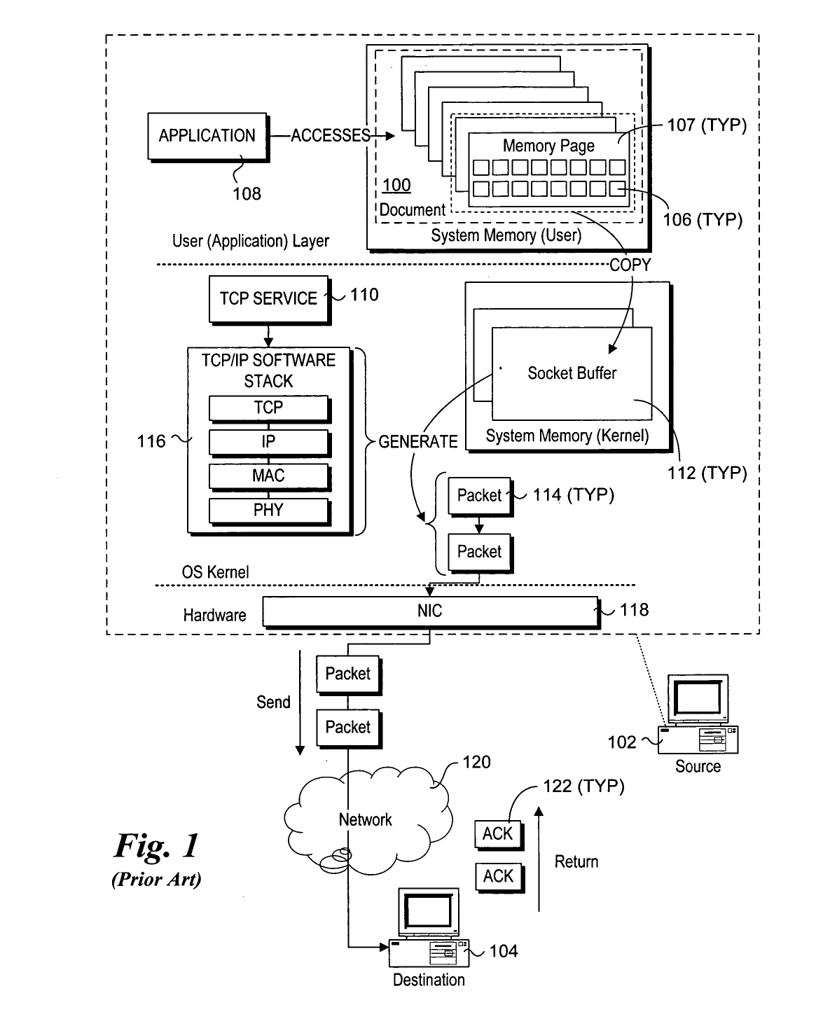

Under one embodiment, non-network applications function (with respect to the operating system and the host platform) in the same manner as application 108 discussed above with reference to FIG. 1. They are allotted a number of memory pages 106 through the OS memory management system using conventional calls, such as malloc( ) (memory allocation). Also as before, the memory pages are allocated to user space, as depicted by document (Doc) 100 in FIG. 2. Under many operating systems, the user space memory is sequestered from the OS kernel memory to ensure that no application may access the OS kernel memory. The OS also provides mechanisms to ensure that a given application may only access memory pages allocated to that application. Thus, with respect to non-network applications 108, the execution environment is the same as provided by a conventional OS.

In contrast to non-network applications, network applications (e.g., network application 202) use a different memory paradigm. Instead of being allocated memory only in user space, network applications may be allocated memory pages from both user space (as depicted by a document 208_{1A} (Net Doc A)) and from a protocol engine memory pool 204 (as depicted by documents 208_{1B} and 208_{N} (Net Doc 1 . . . Doc N)) managed by a transport protocol engine 206 (hereinafter referred to and shown in the drawings as “protocol engine”206 for simplicity). More specifically, application code and data that is not to be transferred over a network may be stored using the conventional user-space memory scheme depicted by memory blocks 106 and memory pages 107, while network data—that is data that is to be transferred over a network—is stored in protocol engine memory pool 204.

In one embodiment, protocol engine (PE) 206 exposes PE memory APIs (application program interfaces) 210 including a get_memory_from_engine( ) API 212 and a Can_reuse( ) API 214 to applications running in the user layer. get_memory_from_engine( ) API 212 functions in a manner that is analogous to a typical system memory API, such as malloc( ). In response to a network application memory request via a corresponding get_memory from_engine( ) call referencing J bytes, a protocol engine memory manager 216 allocates a buffer 218 having storage space sufficient for storing the J bytes from protocol engine memory pool 204, and returns address information via which memory in buffer 218 may be accessed. For example, for page-based memory schemes, buffer 218 may comprising one or more memory pages 107, or a number of memory blocks within a single memory page, depending on J, the memory page size, and the memory block size. In general, the underlying memory scheme employed by the OS/processor is irrelevant to the operations of the zero-copy transmit mechanisms described herein, wherein the mechanisms employ the OS memory management system to allocate memory space for buffers 218.

During operation, network application 202 accesses memory in the normal manner by using read and write calls referencing the memory block(s) (using physical or virtual addresses, depending on the memory management system scheme) to be accessed. These calls are submitted to the memory management system, which, in the case of virtual addressing, transparently translates the referenced virtual addresses into physical addresses at which those blocks are physically stored. Thus, from the perspective of the application, the memory access provided by buffers 218 functions in the same manner as conventional user-space memory access.

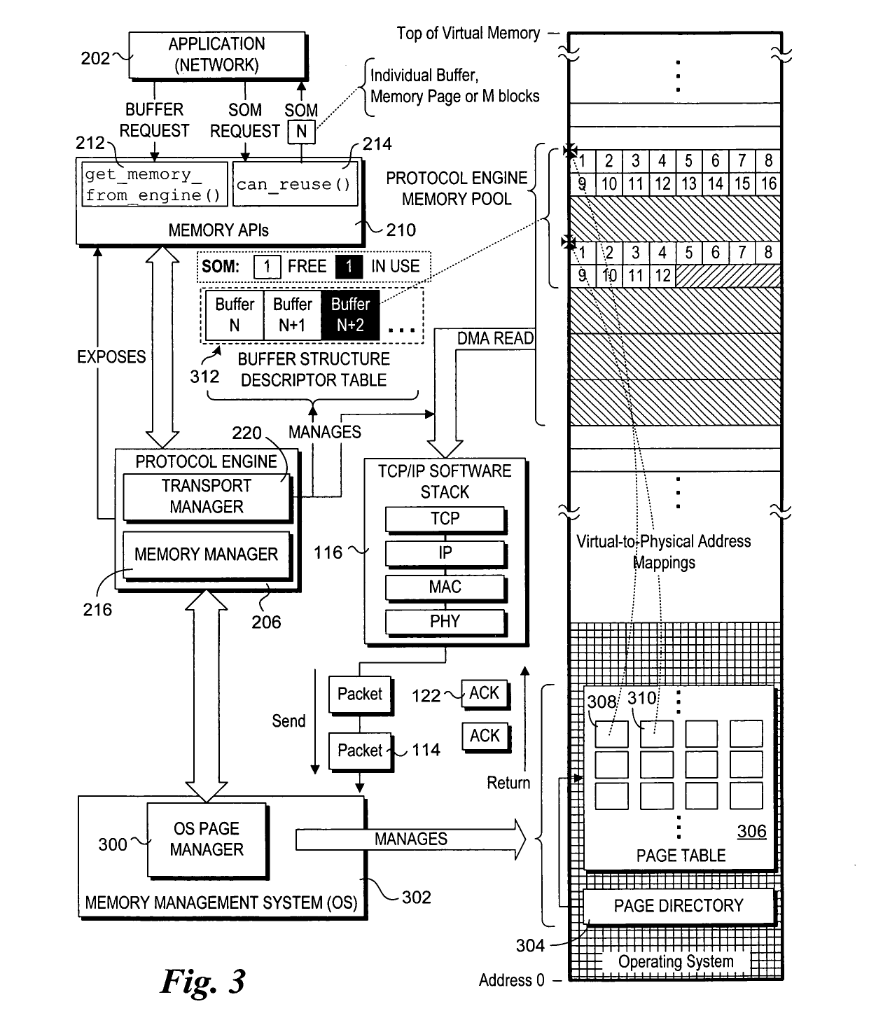

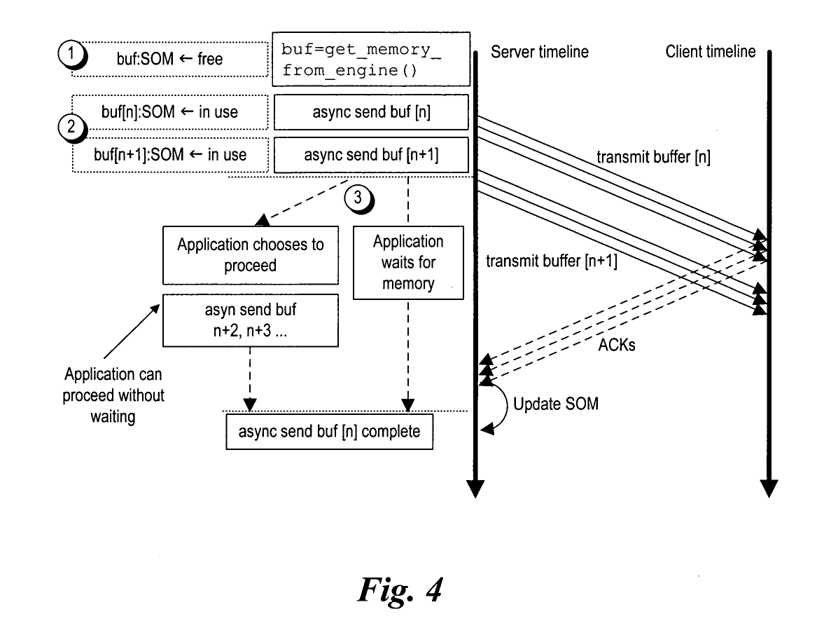

While application memory access aspects are similar to conventional memory usage, network data transmission is not. Rather than employ the copy scheme of FIG. 1, data in protocol engine memory pool 204 may be directly transmitted via corresponding packets 114 under the management of a protocol engine transport manager 220, as depicted in FIG. 2. However, unlike the Linux sendpage( ) scheme, the amount of the data requested to be transferred (as well as the size of the corresponding buffer) is variable, supporting finer control of transfers and providing utilization efficiencies over the sendpage( ) scheme. Furthermore, unlike the sendpage( ) scheme, protocol engine 206 provides feedback to network application 202 to assist the network application in determining the level of network congestion. In view of this information, a throttling mechanism may be implemented by the network application and/or transport manager 220. Further details of the mechanisms and an exemplary transmit process are respectively shown in FIGS. 3 and 4.

Referring to FIG. 3, in one embodiment memory manager 216 interfaces with an OS page manager 300 of an OS memory management system 302. This is the same interface used by conventional memory allocation calls to request allocation of one or more memory pages and is abstracted through the PE memory APIs 210. Under typical memory architectures, access to system memory is managed by a memory management system comprising at least an OS component, and possibly further including a hardware component. For example, under a Microsoft Windows®/Intel® IA-32 (e.g., Pentium 4) platform, a portion of the system memory management is performed by the OS, while another portion is managed by the processor. Such an implementation is shown in FIG. 3, wherein a page directory 304 is employed to access page table entries in a page table 306. As depicted by page table entries 308 and 310, page table 306, along with the underlying processor hardware, provides virtual-to-physical address mappings for each memory page that is managed by the memory management system. Depending on the particular implementation, the memory pages can vary in size (e.g., 4K, 8K, 16K . . . etc. for a Windows OS, 4K and 4 Meg for Linux, various sizes for other OS's). This scheme allows the logical (virtual) addressing of memory pages for a given application to be sequential (the application is allocated a buffer 218 having a contiguous memory space), while the physical location of such memory pages may be discontinuous, with the mappings being entirely transparent to the applications.

In addition to conventional memory data structures, protocol engine 206 maintains a buffer structure descriptor table 312. The buffer structure descriptor table includes information identifying the addresses of the buffers used for network transmissions. From a memory-level viewpoint, the buffers are analogous to the socket buffers referenced in FIG. 1. In one embodiment, a buffer and a memory block on a memory page are synonymous. Accordingly, buffer structure descriptor table 312 includes information corresponding to the memory components (e.g., memory blocks, memory pages, etc. in protocol engine memory pool 204 allocated for each buffer 218. The buffer structure descriptor table further includes a State-of-Memory (SOM) field for each buffer. The SOM field identifies whether a corresponding buffer is in use or free.

During a typical application cycle, all or a portion of memory allocated to the application from protocol engine memory pool 204 may be reused, thus reducing the amount of memory required by the application to perform its data transfer operations. For example, for a web server application, dynamic content (e.g., scripts, graphical content, dynamic web pages) of various sizes may be dynamically generated, using data storage allocated from protocol engine memory pool 204 as buffers 218. Appropriate data in the application's allocated buffers are then packaged into packets, and transported to various destinations. For ongoing operations, it will be advantageous to reuse the same buffer space allocated by protocol engine 220 for the application. This is facilitated, in part, through use of the SOM field values.

One embodiment of the corresponding network transfer processing is schematically illustrated in FIG. 4. The process begins at an operation 1 (depicted by an encircled 1), wherein a network application running on a web server requests allocation of one or more buffers 218 from protocol engine memory pool 204 using the get_memory_from_engine( ) API 212. As the buffers become filled with data, they are marked via the SOM field as “in use.” This is depicted by operation 2 and corresponding buffers [n] and [n+1] in FIG. 4. Under the control of transport manager 220, protocol engine 206 will cause corresponding packets 114 to be generated from the various buffers (e.g., buffers [n] and [n+1]) using TCP/IP software stack 116 and transmitted to the network via NIC 118 using an asynchronous transfer, as also depicted at operation 2.

In view of network conditions and forwarding latencies, it will take a finite amount of time for the transferred packets to reach the destination client. Similarly, it will take a finite amount of time for each ACK packet 122 to be returned from the client to the server to indicate that the packet was successfully received. This “round-trip” timeframe is depicted at the right-hand side of FIG. 4, wherein the multiple arrows are representative of multiple packets being transmitted.

In response to received ACK packets, transport manager 220 updates the SOM values of the corresponding buffers. As each packet is generated, its corresponding packet sequence number is mapped to the buffer(s) from which the packet's payload is copied. (In practice, the buffer data in copied into another buffer in the NIC using a DMA (Direct Memory Access) data transfer, and the applicable protocol header/footer is “wrapped” around the payload for each layer to build the ultimate payload data unit (PDU) that is transmitted, such as an Ethernet frame, although under some implementations it may be possible to build the packet “in-line” without using such NIC buffering, wherein the protocol engine memory pool buffer also functions as a virtual NIC buffer. With respect to the “zero-copy” terminology used herein, the transfer of data into a NIC buffer to build a PDU does not constitute a per se copy.) A corresponding ACK packet (sent from a client in response to receiving the transmitted packet) will likewise identify the sequence number. Based on the sequence number (as well as other header information, if needed), transport manager 220 will identify which buffer(s) the successfully-delivered packet corresponds to, and that buffer's packet indicia will be marked as delivered.

Depending on the implementation, SOM values may be maintained at one or more levels of granularity. For example, in one embodiment SOM values are maintained at the individual buffer level, as depicted in FIGS. 3 and 4. SOM values may also be maintained at levels with more granularity, such as at the memory page level or even memory block level. In the memory page case, an SOM value for an entire memory page is maintained, with the SOM value being marked as “in use” if any packets corresponding to the portion of a buffer's data stored on that memory page have not been successfully transferred.

During this round-trip timeframe, the application will continue to run, behaving in the following manner. In connection with obtaining more memory (either through new memory page allocation, or, more typically, through reuse), the application may explicitly check the SOM value (e.g., at the individual buffer or memory page level) using the can_reuse( ) API 214. In response to the SOM value, the application can decide whether to proceed with further data transfers or wait until more buffers are available, as shown at operation 3 in FIG. 4. Optionally, the application can leave the decision to the protocol engine memory manager 216 to release only usable memory (i.e., available buffers/pages from previously-allocated memory space) when granting new memory allocations from protocol engine memory pool 204.

Under the explicit check mechanism, the application is able to gauge the level of back-pressure due to network congestion. If it is attempting to transfer data too fast (as indicated by unavailable buffers and/or memory pages) relative to the network bandwidth, it, can throttle back the transfer rate so to not overrun the network. Conversely, if buffers and/or memory pages are readily available, the application may attempt to increase the transfer rate.

The protocol engine also has a level of control over the transmission process. If it has available memory resources (in terms of free memory space that has yet to be allocated to any application), it may choose to allocate those resources. On the other hand, it may decide to selectively throttle some applications via its memory-allocation policy, while letting other applications proceed to effect a form of flow control and/or load balancing.

Exemplary Computer Server System

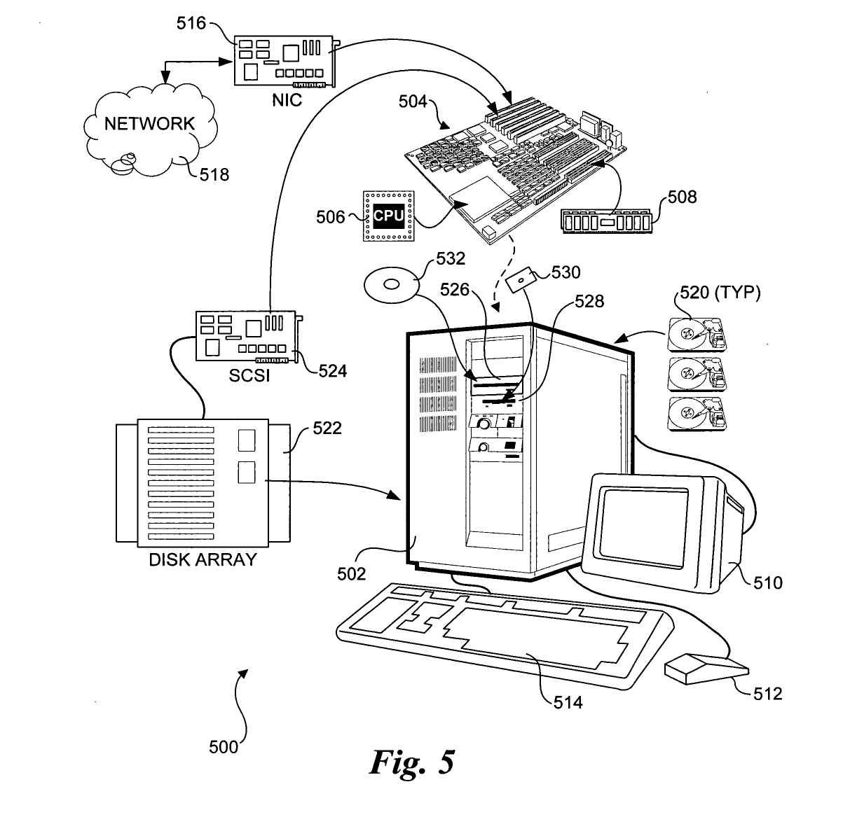

With reference to FIG. 5, a generally conventional computer server 500 is illustrated, which is suitable for use in connection with practicing aspects of the embodiments described herein. For example, computer server 500 may be used for running the application and kernel layer software modules and components discussed above. Examples of computer systems that may be suitable for these purposes include stand-alone and enterprise-class servers operating UNIX-based and LINUX-based operating systems, as well as servers running the Windows-based Server (e.g., Windows Server 2000, 2003) operating systems. Other operating systems and server architectures may also be used.

Computer server 500 includes a chassis 502 in which is mounted a motherboard 504 populated with appropriate integrated circuits, including one or more processors 506 and memory (e.g., DIMMs or SIMMs) 508, as is generally well known to those of ordinary skill in the art. A monitor 510 is included for displaying graphics and text generated by software programs and program modules that are run by the computer server. A mouse 512 (or other pointing device) may be connected to a serial port (or to a bus port or USB port) on the rear of chassis 502, and signals from mouse 512 are conveyed to the motherboard to control a cursor on the display and to select text, menu options, and graphic components displayed on monitor 510 by software programs and modules executing on the computer. In addition, a keyboard 514 is coupled to the motherboard for user entry of text and commands that affect the running of software programs executing on the computer. Computer server 500 also includes a network interface card (NIC) 516, or equivalent circuitry built into the motherboard to enable the server to send and receive data via a network 518.

File system storage, such as may be used for storing Web pages and the like, documents, etc., may be implemented via a plurality of hard disks 520 that are stored internally within chassis 502, and/or via a plurality of hard disks that are stored in an external disk array 522 that may be accessed via a SCSI card 524 or equivalent SCSI circuitry built into the motherboard. Optionally, disk array 522 may be accessed using a Fibre Channel link using an appropriate Fibre Channel interface card (not shown) or built-in circuitry, or any other access mechanism.

Computer server 500 generally may include a compact disk-read only memory (CD-ROM) drive 526 into which a CD-ROM disk may be inserted so that executable files and data on the disk can be read for transfer into memory 508 and/or into storage on hard disk 520. Similarly, a floppy drive 528 may be provided for such purposes. Other mass memory storage devices such as an optical recorded medium or DVD drive may also be included. The machine instructions comprising the software components that cause processor(s) 506 to implement the operations of the embodiments discussed above will typically be distributed on CD-ROMs 532 (or other memory media) and stored in one or more hard disks 520 until loaded into memory 508 for execution by processor(s) 506. Optionally, the machine instructions may be loaded via network 518 as a carrier wave file.

Thus, embodiments of this invention may be used as or to support software components, modules, and/or programs executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
allocating memory buffers to an application running in a user layer of an operating system (OS) from a memory pool in OS kernel space managed by a transport protocol engine; and
directly transferring data stored in the memory buffers to a network via a network interface controller (NIC) using a zero-copy transmit mechanism managed by the transport protocol engine.

2. The method of claim 1, further comprising:
providing feedback information to the application from which the application can determine network availability.

3. The method of claim 2, wherein the feedback information includes information identifying storage availability in a memory buffer that has previously been allocated to the application.

4. The method of claim 3, wherein the storage availability information indicates whether the entire memory buffer is available, the method further comprising:
determining that the memory buffer is available;
reusing the memory buffer to store new data; and
transferring the new data from the memory buffer to the network using the zero-copy transmit mechanism.

5. The method of claim 3, wherein the storage availability information indicates whether a portion of the memory buffer comprising one of a memory page or memory block is available, the method further comprising:
determining that the one of a memory page or memory block is available;
reusing the one of a memory page or memory block to store new data; and
transferring the new data from the one of a memory page or memory block to the network using the zero-copy transmit mechanism.

6. The method of claim 1, further comprising:
receiving a request from the application for a new memory allocation; and
allocating memory corresponding to the new memory allocation from one or more existing memory buffers previously allocated to the application.

7. The method of claim 2, further comprising:
sending data to the network using a first transfer rate controlled by the application;
monitoring memory buffer availability under the first transfer rate;
detecting network congestion is present based on the memory buffer availability; and
throttling back the first transfer rate via the application to send data to the network using a lower, second transfer rate.

8. The method of claim 1, further comprising:
allocating memory from a user space comprising a user layer portion of system memory to the application; and
employing the memory to store at least one of executable code for the application and data used by the application that is not transmitted to the network.

9. The method of claim 8, further comprising:
employing a first application program interface (API) to allocate memory from the user space; and
employing a second API to allocate memory from the memory pool in the OS kernel space.

10. The method of claim 9, further comprising:
employing an underlying OS memory management system to allocate memory from each of the user space and the memory pool in the OS kernel space, wherein the second API provides a layer of abstraction between the application and the OS memory management system.

11. The method of claim 1, wherein the transmit protocol engine employs a TCP/IP (Transmission Control Protocol/Internet Protocol) stack to effect transfer of data to the network.

12. A method, comprising:
allocating a first portion of memory to an application from a user space of system memory;
allocating a second portion of memory comprising one or more memory buffers to the application from a operating system (OS) kernel space of the system memory; and
effecting a zero-copy transmit mechanism to transmit data from the one or more memory buffers to a network.

13. The method of claim 12, wherein the application comprises a web server application, and the memory buffers are used by the web server to store dynamically generated content that is transmitted to clients via the network.

14. The method of claim 12, further comprising:
exposing a first application program interface (API) to applications running in a user layer via which memory from the user space is allocated; and
exposing a second API to the user layer via which memory from the memory pool in the OS kernel space is allocated.

15. The method of claim 12, further comprising:
initiating transmission of data from a memory buffer;
maintaining state of memory information identifying an availability for reuse of at least one of an entire memory buffer, a memory page allocated for the memory buffer, and a memory block allocated for the memory buffer; and
exposing a buffer reuse application program interface (API) to applications running in a user layer to enable the applications to obtain the state of memory information.

16. The method of claim 15, further comprising:
sending data to the network using a first transfer rate controlled by the application;
obtaining state of memory information via the buffer reuse API;
detecting network congestion is present based on the state of memory information; and
throttling back the first transfer rate via the application to send data to the network using a lower, second transfer rate.

17. A machine-readable medium to store instructions comprising a transport protocol engine module, which if executed perform operations comprising:
allocating memory buffers to an application running in a user layer of an operating system (OS) from a memory pool in OS kernel space managed by the transport protocol engine module; and
transferring data stored in the memory buffers to a network via a TCP/IP (Transmission Control Protocol/Internet Protocol) stack and a network interface controller (NIC) using a zero-copy transmit mechanism.

18. The machine-readable medium of claim 17, wherein execution of the instructions perform further operations comprising:
exposing a memory application program interface (API) to a user layer of the OS via which memory buffers from the memory pool in the OS kernel space are allocated.

19. The machine-readable medium of claim 18, wherein execution of the instructions perform further operations comprising:
interfacing with an OS memory management system to obtain system memory resources used for the memory buffers.

20. The machine-readable medium of claim 17, wherein execution of the instructions perform further operations comprising:
maintaining a buffer structure descriptor table in which information corresponding to memory buffers allocated to applications are stored, the information including state of memory information identifying an availability for reuse of one at least one of an entire memory buffer, a memory page allocated for the memory buffer, and a memory block allocated for the memory buffer; and
exposing a buffer reuse API to applications running in a user layer of the OS to enable the applications to obtain the state of memory information
